(19) United States
(12) Patent Application Publication
(10) Pub. No.: US 2003/0041336 A1
(43) Pub. Date: Feb. 27, 2003

(54) Selective downloading of specific code images to broadband terminals

(75) Inventors: Chris Del Sordo, Souderton, PA (US); Jack M. Birnbaum, Southampton, PA (US); Robert M. Simons, Lansdale, PA (US)

Correspondence Address: LAW OFFICE OF BARRY R LIPSITZ, 755 MAIN STREET, MONROE, CT, 06468, US

(73) Assignee: General Instrument Corporation, Horsham, PA (US)

(21) Appl. No.: 09/901,820

(22) Filed: Jul. 10, 2001

(51) Int. Cl. H04N 7/16

(52) U.S. Cl. 725/140

(57) ABSTRACT

Methods and apparatus are provided for distributing software code to particular end user terminals in a broadband network. Code images are provided to the broadband terminals via a collection of objects structure. In an illustrated embodiment a network system controller, such as a CATV headend, transmits an image that includes a Code Section Lookup Table followed by a common code section. The common code section is followed by specific code sections for the broadband terminals coupled to the network. For example, specific code sections can be provided for (i) different hardware configurations in the broadband terminal operator's population, (ii) different device driver code necessary to support primary and second-sourced broadband terminals, (iii) a plurality of different broadband terminal models coupled to the network; (iv) different software features available to the broadband terminals, and/or (v) different protocols supported in the field.

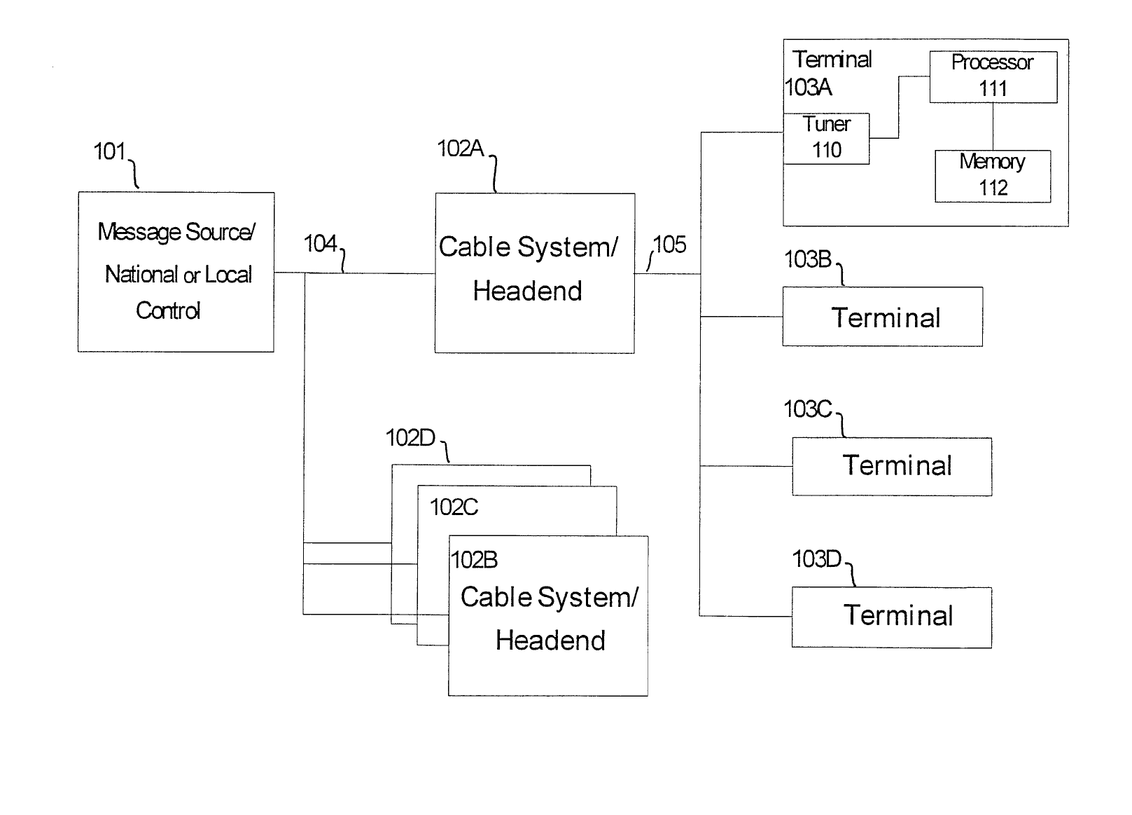

### BACKGROUND OF THE INVENTION

The present invention relates to an improved system and methods for distributing software code to particular end user terminals in a broadband network, such as a cable television (“CATV”) network or the like. In the illustrated embodiments, code images are distributed to set-top terminals and the like via a collection of objects structure.

The term “code image” or “software image” is used herein to mean the executable software run by the broadband terminal's microprocessor.

In a typical cable television system, subscribers are provided with a broadband communications terminal, often referred to as a “set-top box.” A broadband communications terminal contains the electronic equipment that is used to connect the subscriber's television, and potentially other electronic equipment, with the cable network. The broadband communications terminal is usually connected to the cable network through a coaxial cable wall outlet.

The broadband communications terminal is essentially a computer programmed to process the signals from the cable network to provide the subscriber with cable services. Cable services are controlled by a cable television company and typically include a number of basic television channels, premium channels (which may be provided to subscribers at an additional fee) and pay-per-view events. The broadband communications terminal is programmed to provide these services to the subscriber.

However, the services of the cable company need not be limited to providing television programming. The services that the subscriber may receive might also depend on the type of broadband terminal and the platform/middleware/application code that resides and executes in that terminal. Some cable companies are now offering Internet access and e-mail over the cable network at speeds much faster than are available over conventional telephone lines. It is anticipated in the future that more and more services will be commonly provided over cable networks, including video on demand and even basic telephone service.

Different broadband terminal models will typically vary in the actual hardware used therein, including their circuit board configurations. This may require different software platform code to be provided to different terminals, in order to enable the execution of similar or enhanced functionality via the different hardware environments. Eventually, each home or office may have a single connection, via the cable network, to all electronic data services.

A “headend” is the facility from which a cable network operator broadcasts television signals and provides other services over the cable network. Although the present invention is described herein in connection with a broadband cable television network, it should be appreciated that the invention is applicable to other networks as well, including wired and wireless global computer networks, local area networks, wide area networks, and the like. Accordingly, the term “headend” as used herein is not to be construed as being limited to a CATV network.

Updated software that is provided to the population of broadband communications terminals can be broadcast from the headend over the cable network. Messages giving instructions or information to the broadband communications terminals can also be broadcast by the headend over the broadband network. Software objects (i.e. executable software images) are broadcast via the headend(s) by a local, regional, national, or international controller. With a local or regional controller, the controller can be part of the headend. With a national or international controller, the messages are typically broadcast over a satellite.

The messages and objects intended for the broadband communications terminals are typically “packetized,” meaning that the data of the message or the software or firmware object is divided into discrete “packets” or segments of data. Each packet includes a header that identifies the message or object of which that packet is a part. The header also identifies the position of that packet's data within that message or object. Consequently, the broadband communications terminal can collect the packets of the message or object it is trying to acquire and reassemble the packetized data into the message or object sent by the headend. The packets of each data object being transmitted bear a unique packet identifier (PID), typically a number or other identifier within the PID stream, that identifies the packets as belonging to a particular message or data object being transmitted.

With messages and objects being packetized, numerous messages and objects can be broadcast simultaneously by interspersing or “carouseling” the packets of the various items being transmitted. The packets of each message or object may be continuously transmitted and retransmitted for a period of time to give broadband communications terminals a continuing opportunity to acquire the message or object. These streams of data packets can be sent on in-band and/or out-of-band (OOB) channels of the broadband signal sent from the headend to the broadband communications terminals.

The system operator will periodically need to reprogram the broadband communications terminals to accommodate upgrades or additional services offered by the broadband system. It is important for the headend to be able to direct specific terminals, or an identified group of terminals to download and acquire new programming. As the cable network and the services provided evolve, the broadband communications terminal must also evolve to be able to provide subscribers with all the services of the cable network. This service evolution will involve changes to the programming in the broadband communications terminal, upgrading of the broadband terminal hardware, and upgrading of the platform software which will include updating of the software features provided in the terminal. By upgrading the software or firmware, the broadband communications terminal can be made to perform more efficiently or offer new services as the broadband network evolves. Moreover, the broadband terminals may differ somewhat in the actual hardware chips resident on a main-board and in the main-board configurations themselves. This may require different platform code to execute similar or enhanced functionality on the different hardware environments.

The broadband terminals may also differ in model type, meaning that different hardware features may be installed at the factory for a broadband terminal. This, in turn, may require different platform software images to control the different hardware features.

Another scenario that poses a problem for broadband environments and code distribution is when a “second source” of a particular broadband terminal model of one manufacturer is provided by a different manufacturer. In this case, the hardware and associated device drivers (i.e., code that interfaces directly with the hardware) provided by the second source manufacturer are typically different from the hardware and device drivers of the original manufacturer. The higher-level code that processes the system protocol associated with the broadband terminal, as well as the middleware and high-level platform code is usually specific to the original manufacturer (i.e., the primary source). In this instance, a family identifier is stored into the broadband terminal when it is manufactured. The family identifier can be used to identify the code sections that need to be loaded to provide the appropriate device drivers and middleware and high-level platform software.

With all the differences in software and hardware features that can be provided in a broadband communications terminal, the downloading of code images requires some mechanism for sending a single code image that includes all the combinations of code sections (i.e., part of a final executable) and associated information that can be used to load the appropriate executable images for a particular situation. One of the problems in the broadband environment is that it is not acceptable for a headend to manage many code images simultaneously on the existing Control Channel. Although separate code images could be transmitted simultaneously over the air, this is not a practical solution. Over time, as new broadband terminals enter the population, the code images would grow exponentially, resulting in an unacceptable situation from the perspective of broadband terminal operators. Moreover, it would not be possible for one code image executing in the terminal to address all the different functionality required by all the variations of hardware and software, because storage of the code image would require too much expensive memory. In particular, all of the executable code would have to be provided for all the different scenarios. Such a solution would also complicate the final image, in that it would have to decide which environment it is running in and startup the correct code. It would therefore be advantageous to provide efficient and cost-effective methods and apparatus for downloading customized code images to a wide variety of broadband terminals. It would also be advantageous to provide a solution for the problem of maintaining and updating broadband communications terminals in a network, where the terminals may not all comprise the same hardware, device drivers, and the like. It would be still further advantageous to provide a mechanism for enabling specific customized software features to be loaded into different broadband communications terminals from a single headend image.

The present invention provides methods and apparatus having the aforementioned and other advantages.

### SUMMARY OF THE INVENTION

In accordance with the invention, methods and apparatus are provided for distributing software code to particular end user terminals in a network. A software image transmitted to the terminals includes a code section lookup table, a common code section for all terminals in the network, and specific code sections for different terminals in the network. Specific code sections are provided for different terminal hardware configurations, different terminal device driver code, different terminal models, different terminal software features, and/or different system protocols.

The common and specific code sections can together include all of the executable code necessary to enable a plurality of different end user terminals coupled to the network to provide services to respective end users.

The software image is processed by the end user terminals to locate and extract common and specific code sections intended for the particular terminal. The extracted common and specific code sections can be stored in the terminal. The code section lookup table can comprise a first section containing information required to enable end user terminals to identify the specific code sections for the terminal, and a second section for enabling the end user terminals to locate the common and specific code sections within the software image. In an illustrated embodiment, the user terminals locate and extract the common code sections using the second section of the code section lookup table. Subsequently, the user terminals locate and extract the specific code sections using the first and second sections of the code section lookup table.

The code section lookup table can include:

(i) Circuit board ID descriptions for identifying specific code sections based on different terminal hardware configurations,

(ii) Family ID descriptions for identifying specific code sections based on different terminal manufacturers,

(iii) Model ID descriptions for identifying specific code sections based on different terminal models, and/or

(iv) Software ID descriptions for identifying specific code sections based on different terminal software features.

Software IDs can be provided to the terminals via (i) end user input and/or (ii) a system message. The code section lookup table can also include Platform ID descriptions for identifying specific code sections based on different terminal platforms. Additionally, the code section lookup table can include Protocol ID descriptions for identifying specific code sections based on different system (e.g., headend) protocols. The Protocol IDs can, for example, be provided to the terminals from a headend. The code section lookup table can further include an identifier for identifying specific code sections containing customized versions of application code objects to be distributed to particular ones of said end user terminals.

Apparatus is provided for distributing software code to particular end user terminals in a broadband network. The apparatus comprises a processor for providing a software image that includes a code section lookup table, a common code section for all terminals in the network, and specific code sections for different terminals in the network. A transmitter communicates the software image to the terminals. Specific code sections can be provided for different terminal hardware configurations, different terminal device driver code, different terminal models, different terminal software features, different system protocols, and/or other terminal specific parameters.

A user terminal is disclosed for selectively receiving software code via a network. The user terminal comprises a receiver adapted to receive a software image. The software image includes a code section lookup table, a common code section for a plurality of terminals in the network, and specific code sections for different terminals in the network. A processor locates and extracts common and specific code sections intended for the user terminal Memory is provided for storing the extracted code sections.

The terminal can comprise, for example, a set-top box for use in a subscription television system or the like. A user interface can be provided to enable an end user to provide a Software ID for identifying a specific software feature to be located and extracted for subsequent use by the terminal. For example, a Software ID (or associated link) can be selected via the interface to provide an additional service to the end user or enhanced functionality for the terminal.

### BRIEF DESCRIPTION OF THE DRAWINGS

The Figure is a block diagram of a broadband network including a headend and a population of broadband communications terminals with which the present invention can practiced.

### DETAILED DESCRIPTION OF THE INVENTION

In accordance with the present invention methods and apparatus are provided, e.g., using a novel algorithm, that allows selective code section downloads from a transmitted headend image by a resident executable System Platform Code Loader (SPCL). The selective downloads are provided according to information stored in a Code Section Lookup Table (CSLT).

There are many reasons why a System Platform Object (SPO) loaded in one broadband terminal will need to differ from the SPO loaded into another broadband terminal. Various example scenarios are set forth hereinafter that depict situations requiring different System Platform Object execution within differing broadband terminals. In configuring and operating such terminals, neither (i) a single object that will handle all variations nor (ii) transmitting multiple objects via a control channel are acceptable solutions to broadband terminal operators who have to deal with different SPOs.

In accordance with the present invention, the headend transmits a code image that includes a collection of all the code sections that are required to provide the executable code necessary for a plurality of different broadband terminal environments. In order to support a population of terminals contained in a particular broadband network, all of the represented environments will have to be accommodated by the system operator. Thus, the invention provides a headend image which is transmitted with a Code Section Lookup table attached in front of all the code sections. A code section is defined to be a monolithic piece of computer software code that will be loaded from the headend download message(s) to a non-volatile storage memory (e.g., FLASH, hard drive or battery backed random access memory (RAM)) contained in the broadband terminal.

The Figure illustrates, in block diagram form, an example broadband network in which present invention is practiced. As can be seen, the network includes one or more headends 102A, 102B, 102C and/or 102D, and population of broadband communications terminals 103A, 103B, 103C, and/or 103D. A message source or controller 101 (which can be national or local) is coupled to the headend facility 102 via a communication path 104. The communication path may be established, for example, via wired or wireless communications, including without limitation, satellite, microwave, radio frequency (RF), and/or optical communications, and can be configured, e.g., using one or more (or a combination) of a local area network (LAN), wide area network (WAN) or the like, depending on the specific configuration required. The headend facility is connected, e.g., via a cable network 105 to a population of broadband communications terminals 103. Each broadband communications terminal 103 is programmed to provide those services available over the cable system that the subscriber has paid to receive.

In addition to providing services, such as a cable television signal, the headends 102 (or the controller 101) can also include one or more computer processors for constructing code and data objects for transmission to the broadband communications terminals 103 over the cable network. Provision of other services to the terminals 103 can also be provided by the headend.

As illustrated, each terminal 103 can comprise a tuner 110, a processor 111 and memory 112. These components are conventional, and their operation is well known in the art. The code section(s) downloaded from the headend in accordance with the present invention can be stored, for example, in memory 112.

As indicated above, the headend image is transmitted with a Code Section Lookup Table. This table will typically be prepared by one or more processors at the headend, although it can also be created at a remote source, such as, for example, the controller 101. One example of such a lookup table is described in Table 1, which has two main sections, as follows:

TABLE 1
Code Section Lookup Table (300)

Number of Board ID descriptions
Board ID 1
Number of Code Sections for this Board ID
Code Section Number . . .
Board ID 2
Number of Code Sections for this Board ID
Code Section Number . . .
Board ID 3
Number of Code Sections for this Board ID
Code Section Number . . .
(300A)
Number of Family ID descriptions
Family ID 1
Number of Code Sections for this Family ID
Code Section Number . . .
Family ID 2
Number of Code Sections for this Family ID
Code Section Number . . .
Family ID 3
Number of Code Sections for this Family ID
Code Section Number . . .
(300B)
Number of Model ID descriptions
Model ID 1
Number of Code Sections for this Model ID
Code Section Number . . .
Model ID 2
Number of Code Sections for this Model ID
Code Section Number . . .
Model ID 3
Number of Code Sections for this Model ID
Code Section Number . . .
(300C)
Number of Software ID descriptions
Software ID 1
Number of Code Sections for this Software ID
Code Section Number . . .
Code Section Number
Software ID 2
Number of Code Sections for this Software ID
Code Section Number . . .
(300D)
Number of Protocol ID descriptions
Software ID 1
Number of Code Sections for this Protocol ID
Code Section Number . . .
Code Section Number
Software ID 2
Number of Code Sections for this Protocol ID
Code Section Number . . .
(300E)

TABLE 1
Second Section (400)

| Code Section | Length of | Code Section | Common/Specific |
|---|---|---|---|
| Number | Code Section | Start Offset | Code Section |
| (400A) | (400B) | (400C) | (400D) |
| 1 | 2000 | 0 | C |
| 2 | 1000 | 2001 | S |
| 3 | 1500 | 3001 | S |

The first section of Table 1 (300A, 300B, 300C, 300D, 300E) contains all the information necessary to inform the resident SPCL to load specific code sections dependent on the identifiers defined in Table 2 (200A, 200B, 200C, 200D, 200E, 200F), below:

TABLE 2
Terminal Identifier Definition Table (200)

Family_ID: Identifies the manufacturer of the broadband terminal. This
identifier is permanently stored (“baked”) into the broadband terminal in
the factory.
(200A)
Board ID: Identifies the particular version of hardware of the broadband
terminal. This identifier is baked into the broadband terminal in the
factory.
(200B)
Model_ID: Identifies the model of the broadband terminal. This identifier
is baked into the broadband terminal in the factory.
(200C)
Software Feature ID: Identifies a specific software feature or a package of
software features. This identifier is entered via consumer interaction or
headend message distribution.
(200D)
Platform_ID: Identifies a unique digital headend transmitted system
platform image. This identifier is baked into the broadband terminal in the
factory.
(200E)
Protocol ID: Identifies a unique headend protocol supported within the
system. This identifier would be sent via the headend configuration.
(200F)

It is noted that the platform identifier 200E is not used for selective code download; instead, it is reserved in the implementation described herein for targeting the entire headend image to a particular broadband terminal. Thus, before the downloading software decides which code segments it should store, it must first determine if the entire headend object is targeted for this type of platform.

Referring back to Table 1, the second section 400 relates to the CSLT and defines the code section start location within the headend image and lengths. In particular, the code section numbers (400A) are referenced to their length (400B) and their start offset (

400C). This part of the table also defines whether a code section is a common section or a specific code section (400D). A common code section is code that will be loaded into all broadband terminals regardless of the terminal or software identifiers. Therefore, in a preferred embodiment the SPCL will first go through the second part of the CSLT and find the common code sections, and load them sequentially into non-volatile memory.

A “specific code section” is a code section that is loaded only if a match is made via the broadband terminal identifiers defined in Table 2 (200A, 200B, 200C, 200D, 200E, 200F). Once all the code sections are loaded and verified, the SPO Code is committed to non-volatile memory in the broadband terminal.

The present invention also provides a way for the broadband terminal headend to control which software features (i.e., software not depedent on the actual hardware) get loaded into the terminal via Softwre Feature ID(s) 200D that are communicated together with the Download Protocol messages or are loaded via interaction with the consumer. These software identifiers are used to load the code sections that are needed to carry out the individual software features or a group of software features associated with the software feature identifiers.

Another situation addressed by the invention is where a single broadband terminal population uses multiple headend protocols for control of the devices in the field. Once again, the broadband terminal is configured via a headend message with a protocol identifier 200F that is used to load specific code sections needed to process a given protocol.

Various scenarios are available in accordance with the invention for downloading specific executable images. Examples of these scenarios follow.

1. Different Hardware Configurations of the Same Manufacturer

The first scenario involves a situation where terminals in the same product line produced by the same manufacturer differ in hardware configuration. The chips resident on the main printed circuit board may differ or the actual main board itself may differ, e.g., due to parts availability and/or product modifications, requiring a different System Platform Object to loaded in different terminals of the same type. Often, the hardware is modified over time due to phased cost-reduction stages or added functionality. Thus, over time the product hardware will evolve and require new execution from the system software.

In this scenario, the headend will transmit a headend image that includes a Code Section Lookup Table 300 followed by a common code section and specific code sections 400 that will include code for each hardware configuration in the broadband terminal operator's population. The first part of the CSLT 300 would include the information similar to section defined in Table 1 300A. This section includes detailed information on which specific code section should be loaded for each board identifier (ID). As can be seen in Table 2 200B, a board identifier is burned into the broadband terminal at the factory and represents the version of hardware which that terminal includes. If it were necessary to load all the code to handle all the different hardware configurations in one System Platform Object, that platform object would become so large that the cost of the non-volatile memory would be prohibitive. Such a solution is not acceptable in a product that sells in the millions of units per year. In this case, the System Platform Code Loader first looks through the second section 400 of the CSLT to find any common code sections. Any such common code sections are loaded into the terminal memory. Then, the SPCL goes back and processes the first part of the CSLT to determine which specific code section(s) it should load immediately after the common section in non-volatile memory.

It should be appreciated that while a particular order of operation is described above, this order is provided as an example only and other implementations are within the realm of the present invention.

2. Second Sourced Manufacturers of the Same Product

A second scenario involves a situation where the same broadband terminal product line is second sourced by another manufacturer. In this instance, a preferred software mix is to have the device driver software provided by the second source manufacturer, since they were the designers of the hardware. The the higher level software would be provided by the manufacturer of the system headend equipment, together with associated protocols and the lower level.

The headend will transmit a headend image that includes a CSLT followed by a common code section which would include the higher level code that is designed by the headend system manufacturer. This will be followed by the specific code sections which will include the lower level device driver code to support the primary and second-sourced broadband terminals. Typically, in a system that has second-sourced broadband terminals, both primary and second-sourced terminals will end up in the some broadband terminal operator's population. The first part of the CSLT would include the information similar to section defined in Table 1 300B. This section includes detailed information on which specific code section should be loaded for each family ID. As can be seen in Table 2 (200A), the family ID is burned into the broadband terminal at the factory and represents the manufacturer of the hardware. Once again, the intent is to save expensive non-volatile memory. In this case, the System Platform Code Loader can first look through the second portion 400 of the CSLT to find any common code sections and loads them. Then, it goes back and processes the first part of the CSLT to determine which specific code section(s) it should load immediately after the common section in non-volatile memory.

3. Different Models of the Same Product for the Same Manufacturer

Different model types of a particular broadband terminal product type will exist in the broadband terminal population at any given time. The different models may have strategically different features. For example, one model type may have an Ethernet port and another may not. This means that the terminals that include the Ethernet port will require an entire TCP/IP Stack and associated Ethernet device driver software to support this port, but the other terminals will not require this code. It is noted that the aforementioned code size issues and management of multiple code images by the system operator apply to such a scenario. It is not practical from the perspective of code size to have a single code image handle all the differences in model version within a particular product type. The platform download algorithm of the present invention solves this problem.

In accordance with the present invention, the headend will transmit a headend image that includes a CSLT followed by a common code section which would include the common code for all model types. This will be followed by the specific code sections for each model type in the field. The first part of the CSLT will include information similar to that defined in 300C, i.e., model ID descriptions. This includes detailed information on which specific code section(s) should be loaded for each model ID (i.e. model type). As can be seen in Table 2 (200C) model ID is burned into the broadband terminal at the factory and represents the particular model of the product. As mentioned above, the model type specifies unique features provided in the designated version of the product. Once again, it is desired to save expensive non-volatile memory. In this case, the System Platform Code Loader first looks through the second portion of the CSLT to find any common code sections (i.e. independent of model type) and loads them. Then, the SPCL goes back and processes the first part of the CSLT to determine which specific code section(s) it should load immediately after the common section in non-volatile memory. If the model identifier matches, the respective specific code section is loaded.

4. Different Software Features Targeted to a Group of Broadband Terminal Customers or a Broadband Customer Has Selected One or More Software Features.

In this scenario, the main goal is to load a specific code image that will provide a unique set of software features. To accomplish this, specific code sections are loaded depending on the software identifiers stored in the broadband terminal. A main difference in this scenario is that the software identifier(s) are not loaded at the manufacturer's factory, as is the case with the scenarios defined above. This is because the software feature required by the consumer is not known when the broadband terminal is manufactured.

In accordance with the invention, software identifiers can be input into the broadband terminal in different ways. The headend could send a configuration message targeted to a specific broadband terminal or a group of broadband terminals with the software identifiers. Another technique for inputting the software identifiers would be for the consumer (i.e., a customer who has the broadband terminal in his/her house) to select software features via a user interface. In such a case, the selection(s) of software features would be translated into software feature identifiers. These identifiers would be used during the downloading of a System Platform. As in the scenarios discussed above, it is not practical from the perspective of code size to have a single code image contain all of the software features used in the entire broadband terminal population. Thus, the platform download algorithm must address this problem.

The headend will transmit a headend image that includes a CSLT followed by a common code section which would include the common code that does not provide the specific software features mentioned above. This will be followed by the specific code sections for each software feature used in the field. The first part of the CSLT would include information similar to that defined in Table 1, section 300D. This section includes detailed information on which specific code section should be loaded for a plurality of software feature identifiers. As can be seen in Table 2, section (200D) represents a particular software feature. Once again, it is desired to save expensive non-volatile memory. In this case, the System Platform Code Loader first looks through the second portion 400 of the CSLT to find any common code sections (i.e. independent of software features) and loads them. Next, it goes back and processes the first part 300 of the CSLT to determine which specific code section(s) it should load immediately after the common section in non-volatile memory. If the software feature ID matches, the respective specific code section is loaded.

5. Different Headend Protocols Supported within a System.

In this scenario, the main goal is to load a specific code image that will provide support for a specific system (e.g., headend) protocol. Specific code sections are loaded dependent on the protocol identifiers loaded in the broadband terminal via headend configuration message(s).

In accordance with the invention, protocol identifiers can be input into the broadband terminal in different ways. The headend could send a configuration message targeted to a specific broadband terminal or a group of broadband terminals with the protocol identifiers. Alternatively, a field applications engineer who installs the broadband terminal at the consumer location (e.g., a home or office) can select the protocol to be supported via a set-up interface, diagnostic interface or the like. The protocol identifiers would be used during the downloading of a System Platform.

The headend will transmit a headend image that includes a CSLT followed by a common code section which would include the common code that is not system protocol depdendent. This will be followed by the specific code sections for each protocol supported in the field. The first part of the CSLT would include information similar to that defined in Table 1 section 300E. This section includes detailed information on which specific code section should be loaded for each protocol identifier. The System Platform Code Loader first looks through the second portion of the CSLT to find any common code sections and loads them. Then, the SPCL goes back and processes the first part of the CSLT to determine which specific code section(s) it should load immediately after the common section in non-volatile memory. If the protocol ID matches, the respective specific code section is loaded.

The present invention provides an ability to extend the code section download mechanism to achieve customized platform downloads for other types of identifiers as the need arises. Also, these identifiers could be used to load customized versions of application code objects. Application code objects are executables that run on top of the platform software object. Examples of software-based applications would include electronic program guides, video-on-demand applications, shopping and bank-at-home applications, games, and the like. It is conceivable that these identifiers could load common and specific code sections from an application based headend image that has a similar code section look-up table attached thereto. The mechanism defined above would be identical for loading of an application.

Finally, in the above descriptions of the inventive algorithms, it is assumed that the final system object has a mechanism to dynamically link these code sections at run time. The first code section, which is usually the common code section, could be absolutely linked in nature, meaning that it knows the address it is supposed to execute at compile time. However, the specific code sections that are to be loaded after the common code sections cannot be absolutely linked. These code sections need to be dynamically linked during the runtime. Typically, different operating systems have their own specific method of dynamic linking, and the required dynamic linking process for implementing the invention with a particular operating system will be apparent to those skilled in the art.

It should now be appreciated that the present invention provides methods and apparatus for distributing software code to particular end user terminals in a broadband network. Algorithms are described for implementing the invention, wherein code images are distributed to broadband terminals via a collection of objects structure. In an illustrated embodiment a network system controller, such as a CATV headend, transmits an image (e.g., “headend image”) that includes a Code Section Lookup Table followed by a common code section. The common code section is followed by specific code sections for the broadband terminals coupled to the network. For example, specific code sections can be provided for (i) different hardware configurations in the broadband terminal operator's population, (ii) different device driver code necessary to support primary and second-sourced broadband terminals, (iii) a plurality of different broadband terminal models coupled to the network, (iv) different software features available to the broadband terminals, and/or (v) different protocols supported in the field.

Although the invention has been described in connection with preferred embodiments thereof, it should be appreciated that various modifications and adaptations may be made thereto without departing from the scope of the invention as set forth in the claims.

What is claimed is:

1. A method for distributing software code to particular end user terminals in a network, comprising:
transmitting a software image that includes a code section lookup table, a common code section for all terminals in the network, and specific code sections for different terminals in the network;
said specific code sections being provided for at least one of:
(i) different terminal hardware configurations,
(ii) different terminal device driver code,
(iii) different terminal models,
(iv) different terminal software features, and
(v) different system protocols.

2. A method in accordance with claim 1, wherein said common and specific code sections together include all of the executable code necessary to enable a plurality of different end user terminals, coupled to said network, to provide services to respective end users.

3. A method in accordance with claim 1, wherein:
said software image is processed by said end user terminals to locate and extract common and specific code sections intended for the particular terminal.

4. A method in accordance with claim 3, wherein the extracted common and specific code sections are stored in the terminal.

5. A method in accordance with 4 wherein said code section lookup table comprises:
a first section containing information required to enable end user terminals to identify the specific code sections for the terminal; and
a second section for enabling the end user terminals to locate the common and specific code sections within said software image for extraction and storage.

6. A method in accordance with claim 5, wherein the user terminals:
locate and extract the common code sections using the second section of said code section lookup table; and
subsequently locate and extract the specific code sections using the first and second sections of the code section lookup table.

7. A method in accordance with claim 1, wherein said code section lookup table includes Board ID descriptions for identifying specific code sections based on different terminal hardware configurations.

8. A method in accordance with claim 1, wherein said code section lookup table includes Family ID descriptions for identifying specific code sections based on different terminal manufacturers.

9. A method in accordance with claim 1, wherein said code section lookup table includes Model ID descriptions for identifying specific code sections based on different terminal models.

10. A method in accordance with claim 1, wherein said code section lookup table includes Software ID descriptions for identifying specific code sections based on different terminal software features.

11. A method in accordance with claim 10 wherein Software IDs are provided to said terminals via at least one of (i) end user input and (ii) a system message.

12. A method in accordance with claim 1, wherein said code section lookup table includes Protocol ID descriptions for identifying specific code sections based on different system protocols.

13. A method in accordance with claim 12 wherein Protocol IDs are provided to said terminals from a headend.

14. A method in accordance with claim 1, wherein said code section lookup table includes an identifier for identifying specific code sections containing customized versions of application code objects to be distributed to particular ones of said end user terminals.

15. Apparatus for distributing software code to particular end user terminals in a broadband network, comprising:
a processor for providing a software image that includes a code section lookup table, a common code section for all terminals in the network, and specific code sections for different terminals in the network; and
a transmitter for communicating the software image to said terminals;
said specific code sections being provided for at least one of:
(i) different terminal hardware configurations,
(ii) different terminal device driver code,
(iii) different terminal models,
(iv) different terminal software features, and
(v) different system protocols.

16. A user terminal for selectively receiving software code via a network, comprising:
a receiver adapted to receive a software image;
said software image including a code section lookup table, a common code section for a plurality of terminals in the network, and specific code sections for different terminals in the network;
a processor for locating and extracting common and specific code sections intended for said user terminal; and
memory for storing the extracted code sections.

17. A user terminal in accordance with claim 16, wherein specific code sections are provided for at least one of:
(i) the user terminal hardware configuration,
(ii) the user terminal device driver code,
(iii) the user terminal model,
(iv) user terminal software features, and
(v) network system protocols.

18. A user terminal in accordance with claim 16, wherein said common and specific code sections together include all of the executable code necessary for said user terminal to provide services to an end user.

19. A user terminal in accordance with claim 16, wherein the terminal is a set-top box for use in a subscription television system.

20. A user terminal in accordance with claim 16, wherein said code section lookup table comprises:
a first section containing information required to enable the user terminal to identify the specific code sections for the terminal; and
a second section for enabling the user terminal to locate the common and specific code sections within said software image for extraction and storage.

21. A user terminal in accordance with claim 16, wherein the user terminal:
locates and extracts the common code sections using the second section of said code section lookup table; and
subsequently locates and extracts the specific code sections using the first and second sections of the code section lookup table.

22. A user terminal in accordance with claim 16, further comprising:
a user interface adapted to enable an end user to provide a Software ID for identifying a specific software feature to be located and extracted.
